(19) United States
(12) Patent Application Publication
(10) Pub. No.: US 2003/0038782 A1
(43) Pub. Date: Feb. 27, 2003

(54) Computer mouse and stand-mounted mouse pad system

(76) Inventor: Tomislav Dobrich, Tecumseh (CA)

Correspondence Address: ANTONY C. EDWARDS, SUITE 800, 1708 DOLPHIN AVENUE, KELOWNA, BC, V1Y 9S4, CA

(21) Appl. No.: 09/938,556

(22) Filed: Aug. 27, 2001

(51) Int. Cl. G09G 5/08

(52) U.S. Cl. 345/163

(57) ABSTRACT

A computer mouse and stand-mounted mouse pad system includes a selectively inclinable rigid platform pivotally mounted at an upper end of a floor-stand, and a computer mouse mountable onto the platform for sliding translation thereover. The computer mouse has a releasable magnetic coupler for releasably magnetically mounting the computer mouse onto the platform. The platform is adapted to magnetically adhere to the magnetic coupler.

### FIELD OF THE INVENTION

This invention relates to the field of computer devices and in particular to a system including a mouse magnetically cooperating with inclinable mouse pad mounted on a floor stand.

### BACKGROUND OF THE INVENTION

It is well known to use a roller-ball based computer interfaced pointing device such as generically referred to as a mouse for rolling on a flat surface, normally a desktop, adjacent a keyboard for directing a cursor on a computer screen. It is also documented in prior art such as U.S. Pat. No. 5,765,795 which issued to Alex on Jun. 16, 1998 for a Deformable Computer Mouse Pad, and U.S. Pat. No. 5,678,800 which issued to Markussen on Oct. 21, 1997 for a Computer Mouse Pad Having Inclined Surfaces that the use of a mouse on a mouse pad positioned adjacent a keyboard on a flat desktop may be fatiguing to the user. Consequently, Markussen discloses using an incline support to incline the mouse pad on an inclined work-surface so as to position a user's hand at an angle relative to the table supporting the mouse pad. Alex teaches a deformable mouse pad that may be deformed so as to be mountable onto, for example, the arm of a chair or a thigh of the user so as to allow a user to control the operation of the mouse in a less fatiguing manner.

Applicant is also aware of International Patent Application No. PCT/IB99/01453 published Mar. 2, 2000 under International Publication Number WO 00/11598 for the invention of Jacobs et al. and entitled Computer Mouse. Jacobs et al. disclose the use of magnetic attraction between the roller-ball of a computer mouse and the mouse pad to improve the stability and traction of the ball and to increase the resistance of the ball to movement to make the mouse easier to control and more accurate, the ball containing a magnet and the mouse pad containing a magnetic sheet.

What is neither taught nor suggested, and which it is an object of the present invention to provide, is a selectively inclinable mouse pad pivotally mounted on a floor stand, the stand providing for vertical height adjustment of the pad above the floor on which the stand is placed. Magnetic attraction between a mouse placed on the mouse pad and the pad itself keeps the mouse adhered to the mouse pad when the mouse pad is inclined and lowered into a position, for example, adjacent the lap of a user so as to thus lessen fatigue or to reduce the pain of injury such as from carpal tunnel syndrome.

### SUMMARY OF THE INVENTION

In summary, the computer mouse and stand-mounted mouse pad system of the present invention includes a selectively inclinable rigid platform pivotally mounted at an upper end of a floor-stand, and a computer mouse mountable onto the platform for sliding translation thereover. The computer mouse has a releasable magnetic coupler for releasably magnetically mounting the computer mouse onto the platform. The platform is adapted to magnetically adhere to the magnetic coupler. The floor stand may include a selectively vertically adjustable shaft. The platform may be mounted atop the shaft. The floor stand may include a tripod mount as its base. The floor-stand may include a means for adjusting a height of the platform above a base of the floor-stand and a means for pivotally adjusting an inclination angle of the platform relative to the floor-stand. The height may be generally between 6 and 24 inches measured from a lower-most end of the base.

The upper surface of the platform may be planar. The platform may further comprise a rigid fore-arm rest cantilevered from the platform. The fore-arm rest may also be planar and may have an upper surface generally parallel to an upper surface of the platform.

The magnetic coupler may be a magnetic roller ball rotatably mounted in the mouse, in which case the platform advantageously includes a metal layer. The metal layer may be an uppermost surface of the platform. In a further embodiment not intended to be limiting, the magnetic coupler may be a metal roller ball rotatably mounted in the mouse, in which case the platform advantageously has a magnetized upper or upper-most surface. The magnetized upper surface may include at least one magnetic strip.

### BRIEF DESCRIPTION OF THE DRAWINGS

FIG. 1 is, in side elevation view, the mouse and mouse pad system of the present invention.

FIG. 2 is, in perspective view, the mouse and mouse pad system of FIG. 1.

FIG. 3 is a cross-sectional view along line 3-3 in FIG. 2.

FIG. 4 is, in side elevation enlarged view, the mouse and mouse pad system of FIG. 1.

FIG. 5 is, in isometric view, the mouse pad of FIG. 4.

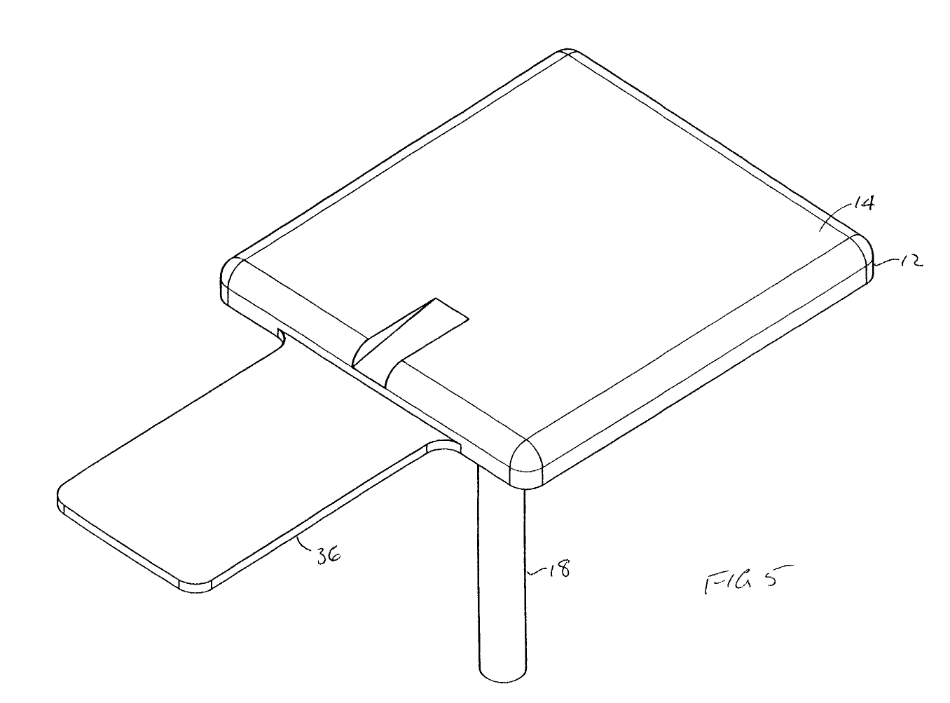

### DETAILED DESCRIPTION OF EMBODIMENTS OF THE INVENTION

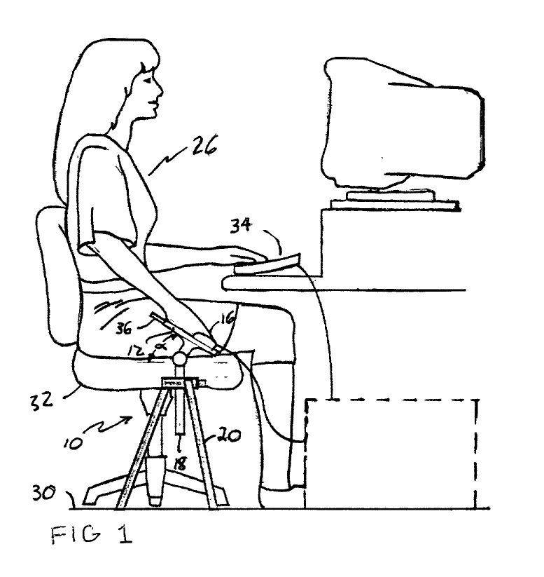

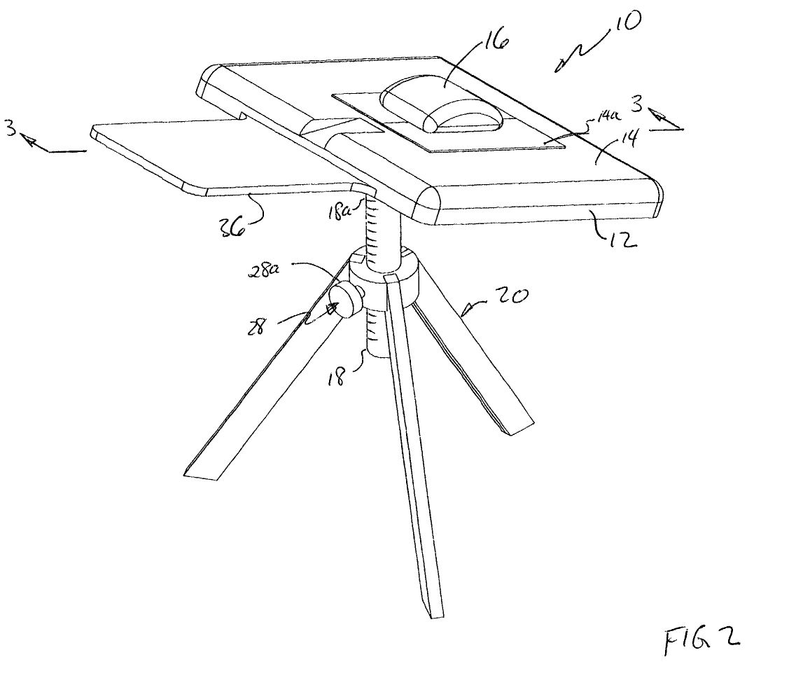

As seen in FIGS. 1 and 2, the mouse and mouse pad system 10 of the present invention includes a rigid generally planar platform 12 which may serve as a mouse pad or to which a mouse pad or like surface 14 may be adhered or otherwise mounted to the upper surface of the platform for sliding translation thereover of a computer mouse 16. Computer mouse 16 is releasably magnetically adhered to surface 14 on platform 12 as better described below so as to allow sliding translation of mouse 16 over surface 14 to allow for the conventional use of the mouse as a pointing and interface device.

Platform 12 is pivotally mounted to the upper end of a vertically adjustable shaft or column 18 adjustably supported within a floor stand or base such as tripod 20.

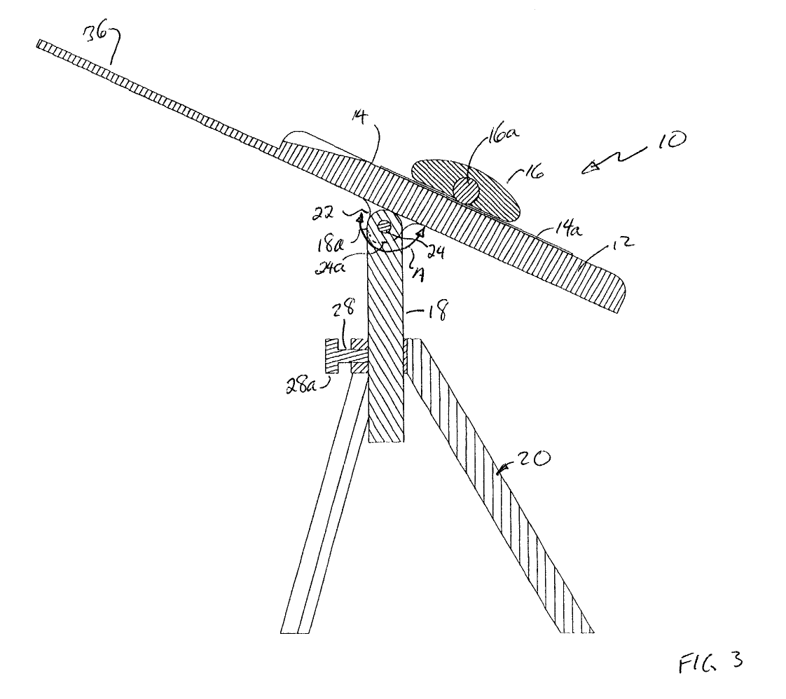

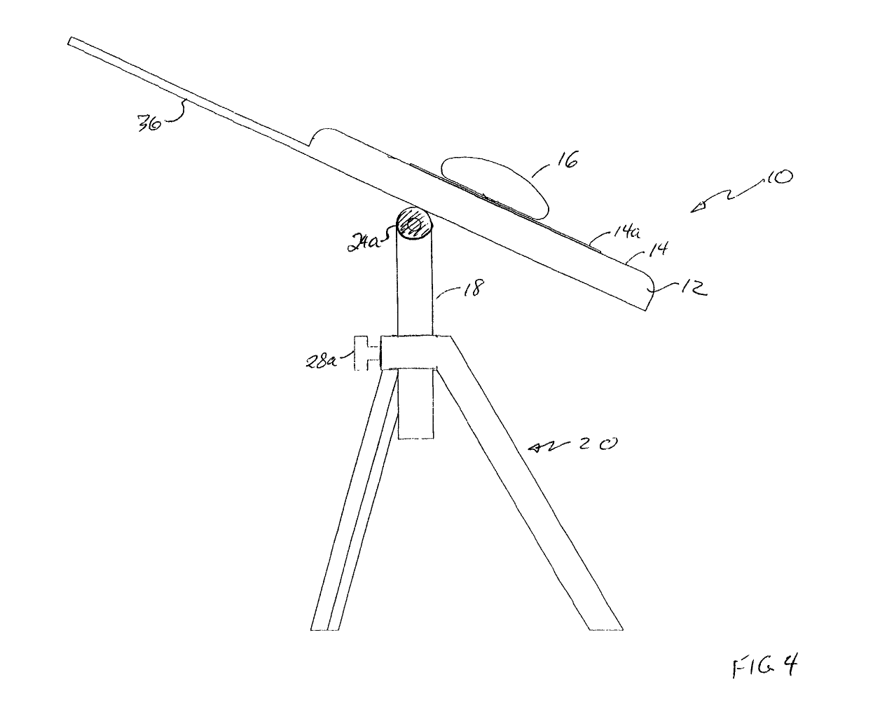

Platform 12 may, without intending to be limiting, be pivotally mounted to shaft 18 by means of a pair of bevelled rigid members 22 extending orthogonally cantilevered from the underside of platform 12, members 22 parallel and spaced apart sufficiently so as to snugly sandwich upper end 18a of shaft 18 between the distal ends of members 22. A shaft or pin 24 or the like is journalled through a laterally disposed bore through end 18a and through correspondingly aligned coaxial bores or apertures in the distal ends of members 22 when mounted over end 18a so as to provide a pivot for rotation of platform 12 in direction A relative to shaft 18 as better seen in FIG. 3. Pin 24 may have a knob 24a at one end as seen in FIG. 4 and may be threaded at its opposite end so as to engage mating threads within the corresponding bore of the corresponding member 22 (not shown). Thus, with members 22 mounted over end 18a and with pin 24 journalled through the coaxial apertures in members 22 and the bore in end 18a, pin 24 may be threadably tightened so as to clamp members 22 together. Clamping members 22 together provides, as an example, for frictionally coupling end 18a between members 22 to thereby releasably lock the position of platform 12 relative to shaft 18 at an angular orientation α as desired by, and comfortable to a user 26.

Shaft 18 may have along its length a row of teeth or serrations or notches or threads which will allow for selective height adjustment of shaft 18 relative to tripod 20. In the embodiment illustrated by way of example, roughened surface 18b frictionally mates with the innermost end of a threaded shaft or bolt 28 when a user tightens the end of the shaft or bolt by rotating knob 28a so as to frictionally engage the end of the shaft or bolt against surface 18b. It may be convenient to provide for an adjustable range of height between floor 30 and platform 12 of between approximately 6 inches and 24 inches to accommodate the various comfort preferences of individual users.

The magnetic adherence of mouse 16 onto platform 12 may be accomplished a number of ways. For retrofit to an existing mouse, the mouse roller ball 16a may be a magnetic roller-ball for magnetic attraction to a metal or otherwise magnetically attractive substrate on or beneath surface 14. For use with a mouse that does not rely on a roller-ball to detect relative translation between the mouse and the mouse pad, for example an optical mouse, then instead of the use of a magnetic roller-ball, magnetic strips (not shown) may be mounted to the underside of the mouse in substitution for the magnetic roller-ball. Alternatively, a sheet magnet 14a or a plurality of discrete magnets may be mounted to, formed in or mounted beneath surface 14 so long as the underside of mouse 16 and/or its roller-ball are of a material, such as metal, which will then magnetically adhere to surface 14.

Thus in use, user 26 positions tripod 20 on the same side of the user as the user would normally position a mouse pad. Thus as an example, if user 26 was right-handed, tripod 20 would be placed on floor 30 to the right of the user when sitting in seat 32 in front of keyboard 34. With tripod 20 so positioned, the height of shaft 18 is adjusted so as to position platform 12, for example, adjacent the seat cushion or the thigh or lap of the user. Platform 12 is inclined forwardly relative to the user when sitting in seat 32 so as to position mouse 16 at a comfortable angle α, comfortable to user 26 when seated in seat 32.

An elongate cantilevered rest pad 36 may be mounted at one end of platform 12 For example, rest pad 36 may be rigidly mounted to platform 12 or telescopically mounted in platform 12 for adjustable sliding in and out of the platform. Rest pad 36 may be generally planar so as to be parallel to, or co-planar with surface 14. Rest pad 36 accommodates resting of the wrist or forearm of user 26 onto the upper surface of the rest pad while the user is holding or manipulating mouse 16.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A computer mouse and stand-mounted mouse pad system comprising:
a selectively inclinable rigid platform pivotally mounted at an upper end of a floor-stand,
a computer mouse mountable onto said platform for sliding translation thereover,
said computer mouse having a releasable magnetic coupler for releasably magnetically mounting said computer mouse onto said platform, said platform adapted to magnetically adhere to said magnetic coupler.

2. The device of claim 1 wherein said floor stand includes a selectively vertically adjustable shaft, and wherein said platform is mounted atop said shaft.

3. The device of claim 2 wherein said floor stand includes a tripod mount.

4. The device of claim 1 wherein an upper surface of said platform is planar.

5. The device of claim 1 further comprising a rigid fore-arm rest cantilevered from said platform.

6. The device of claim 5 wherein said fore-arm rest is planar and has an upper surface generally parallel to an upper surface of said platform.

7. The device of claim 1 wherein said magnetic coupler is a magnetic roller ball rotatably mounted in said mouse and wherein said platform includes a metal layer.

8. The device of claim 7 wherein said metal layer is an uppermost surface of said platform.

9. The device of claim 1 wherein said magnetic coupler is a metal roller ball rotatably mounted in said mouse and wherein said platform has a magnetized upper surface.

10. The device of claim 9 wherein said magnetized upper surface includes at least one magnetic strip.

11. The device of claim 1 wherein said floor-stand includes a means for adjusting a height of said platform above a base of said floor-stand and a means for pivotally adjusting an inclination angle of said platform relative to said floor-stand.

12. The device of claim 11 wherein said height is generally between 6 and 24 inches measured from a lower-most end of said base.

13. The device of claim 12 wherein said base is a tripod.

14. The device of claim 11 wherein said floor stand includes a selectively vertically adjustable shaft, and wherein said platform is mounted atop said shaft.

15. The device of claim 11 wherein an upper surface of said platform is planar.

16. The device of claim 11 wherein said magnetic coupler is a magnetic roller ball rotatably mounted in said mouse and wherein said platform includes a metal layer.

17. The device of claim 16 wherein said metal layer is an uppermost surface of said platform.

18. The device of claim 11 wherein said magnetic coupler is a metal roller ball rotatably mounted in said mouse and wherein said platform has a magnetized upper surface.

19. The device of claim 18 wherein said magnetized upper surface includes at least one magnetic strip.
